(19) United States
(12) Patent Application Publication
(10) Pub. No.: US 2009/0180845 A1
(43) Pub. Date: Jul. 16, 2009

(54) CHARGING DEVICE FOR A SHAFT FURNACE

(75) Inventors: Emile Lonardi, Bascharage (LU); Guy Thillen, Diekirch (LU); Nicolas Maggioli, Thionville (FR)

Correspondence Address: CANTOR COLBURN, LLP, 20 Church Street, 22nd Floor, Hartford, CT, 06103, US

(73) Assignee: PAUL WURTH S.A., LUXEMBOURG (LU)

(21) Appl. No.: 12/306,179

(22) PCT Filed: May 23, 2007
(86) PCT No.: PCT/EP2007/054984

§ 371 Date: Dec. 22, 2008

(30) Foreign Application Priority Data
Jun. 21, 2006 (EP) 06115836.6

(51) Int. Cl. F27D 3/00

(52) U.S. Cl. 414/199

(57) ABSTRACT

A charging device (10; 10′; 10″) for a shaft furnace comprises a distribution chute (20; 20′; 20″; 20′″), which is supported rotatable about an essentially vertical axis of rotation (A), and a variable-speed drive (26) connected to the distribution chute. The variable-speed drive is configured to rotate the distribution chute for circumferential distribution of bulk material on a charging surface of the shaft furnace. According to the invention, the distribution chute comprises multiple chute sections (32, 34, 36, 38) that are interlinked by articulations so as to be capable of forming a curved channel for radial distribution of bulk material on the charging surface, the degree of curvature of said channel being variable in function of the speed of rotation (ω) of the distribution chute.

### TECHNICAL FIELD OF THE INVENTION

In general, the present invention relates to the field of charging shaft furnaces and in particular it relates to a charging device for charging a shaft furnace such as a blast furnace.

### BRIEF DISCUSSION OF RELATED ART

During the last decades a charging system well known by the name “bell-less top” (BLT) has found widespread use throughout the world for charging blast furnaces. This system includes a charging device with a distribution chute that is mounted rotatable about the vertical furnace axis and pivotable about a horizontal axis for distributing bulk material on the stockline. The charging device is further provided with drive equipment for rotating and pivoting the distribution chute according to the desired charging profile. Systems of this type have been disclosed for example in WO 95/21272, U.S. Pat. No. 5,022,806, U.S. Pat. No. 4,941,792, U.S. Pat. No. 3,814,403 and U.S. Pat. No. 3,693,812. By rotating the chute about the vertical furnace axis and by varying the inclination of the chute, it is possible to direct bulk material (burden) to virtually any point of the charging surface. Accordingly, besides many other advantages, the BLT system enables a wide variety of charging profiles due to its versatility in distributing the burden on the charging surface. The charging device of the BLT system does however require highly developed drive equipment, in particular as regards the mechanism capable of rotating and simultaneously pivoting the distribution chute.

Hence, there is a desire for a simpler and less expensive solution as regards the drive equipment associated to the distribution chute. Obviously, such a simpler solution should not lack the desirable versatility in burden distribution.

### BRIEF SUMMARY OF THE INVENTION

Consequently, the invention provides a charging device for a shaft furnace that allows great flexibility in distributing the burden without requiring highly developed drive equipment.

The present invention proposes a charging device for a shaft furnace comprising a distribution chute that is supported rotatable about an essentially vertical axis of rotation, and a variable-speed drive connected to the distribution chute in order to rotate the distribution chute for circumferentially distributing bulk material on a charging surface. According to the invention, the distribution chute comprises multiple chute sections that are connected by respective articulations i.e. interlinked so as to be capable of forming a curved channel for radially distributing bulk material on the charging surface. The degree of curvature of the curved chute is thereby variable in function of the speed of rotation of the distribution chute.

The invention is based on the principle that a suitably designed distribution chute may itself take a curved configuration due to the effect of the centrifugal force caused by rotation of the chute. Once the distribution chute has taken a curved configuration, a given radial velocity component can be imparted to the flow of bulk material (burden) descending there trough, without imposing on the chute any other constraint than rotation. In fact, the invention takes advantage of the effect exerted onto the chute sections of the distribution chute by the centrifugal force that depends on the speed of rotation of the distribution chute and its weight, including the weight of the burden within the chute. With the distribution chute according to the invention, the only actuation required for achieving burden distribution in both radial and circumferential direction is rotation of the chute. As a result, the required drive equipment is greatly simplified and less expensive when compared to prior art charging devices.

In a further embodiment, the distribution chute is unbalanced with respect to its axis of rotation. Although adequate curvature of the burden flow channel could also be achieved with a chute that is balanced in rotation, an unbalanced chute can achieve a certain degree of curvature at comparatively lower speed of rotation and may facilitate control of the degree of curvature, in particular when taking into account the centripetal effect of the burden flow on the chute.

In a preferred embodiment, at least one chute section can comprise an unbalancing weight in order to unbalance the distribution chute. The unbalancing weight is arranged such that, at standstill, the barycentre of the respective chute section is eccentric with respect to the axis of rotation. In order to unbalance the distribution chute, in case at least one pair of adjacent chute sections is interlinked by means of a revolute joint, this revolute joint may have its joint axis offset from the axis of rotation at standstill. Such offset may be provided as an alternative to or in complement to an unbalancing weight.

Preferably, the distribution chute comprises at least three chute sections, which are interlinked by a respective articulation. The maximum inclination angle of the lowermost chute section, which determines the achievable burden distribution radius, increases with the amount of separate chute sections. Furthermore, the achievable overall degree of curvature and the smoothness of curvature of the distribution chute increases with the amount of distinct chute sections. In order to further increase the smoothness of curvature of the burden flow channel formed by the distribution chute, the chute sections advantageously have substantially equal length in flow direction.

In a preferred embodiment, the chute sections are funnel shaped. Funnel shaped chute sections enable a partially interpenetrating overlapping arrangement of the chute sections so as to maintain a circumferentially and longitudinally enclosed channel up to maximum curvature of the articulated chute. Furthermore, in order to obtain a centering effect on the burden flow, it is preferred that, with respect to a pair of adjacent chute sections, the lower chute section is smaller than the upper chute section in terms of the funnel apex angle and the funnel outlet diameter.

Advantageously, each pair of adjacent chute sections is interlinked, i.e. articulated, by means of a revolute joint. This simple form of articulating the chute sections minimizes the available degrees of freedom and thereby facilitates control of curvature, i.e. radial distribution of the burden. Preferably, with respect to a pair of adjacent chute sections, the revolute joint links the lower end portion of the upper chute section to the upper end portion of the lower chute section. In a mechanically simple configuration, the joint axes of the revolute joints are substantially perpendicular to the axis of rotation of the distribution chute and preferably parallel.

Preferably, the chute sections are interlinked with freely pivotable joints configured such that the distribution chute forms a substantially vertical channel at standstill. In a preferred design, the distribution chute comprises a rotatably supported upper inlet channel connected to the variable-speed drive and wherein the uppermost chute section is linked to the lower end of the inlet channel. In yet another preferred embodiment, the distribution chute comprises limit stops for limiting the maximum inclination angle of each chute section.

As will be understood the charging device according to the invention is particularly suitable for equipping a blast furnace.

Furthermore, the invention also concerns a distribution chute to be used in the charging device. This distribution chute comprises multiple chute sections that are interlinked by a respective articulation and thereby capable of forming a curved channel for distributing bulk material radially on a charging surface in function of the speed of rotation of the distribution chute about its longitudinal axis.

### BRIEF DESCRIPTION OF THE DRAWINGS

Further details and advantages of the present invention will be apparent from the following detailed description of several not limiting embodiments with reference to the attached drawings, wherein:

FIG. 1 is a vertical cross sectional view of a blast furnace throat schematically showing a distribution chute of a charging device at standstill;

FIG. 2 is a vertical cross sectional view according to FIG. 1, schematically showing the distribution chute of a charging device at a given speed of rotation;

FIG. 3 is perspective view corresponding to FIG. 2;

FIG. 4 is a schematic diagram of a first embodiment of a charging device;

FIG. 5 is a schematic diagram of a second embodiment of a charging device;

FIG. 6 is a schematic diagram of a third embodiment of a charging device;

FIG. 7 is a vertical cross sectional view schematically showing a distribution chute, of a fourth embodiment of a charging device, at a given speed of rotation.

Identical reference numerals are used to identify identical or similar parts throughout the figures.

### DETAILED DESCRIPTION OF THE INVENTION

FIGS. 4-6 schematically illustrate three embodiments of charging devices at standstill.

A first embodiment of a charging device for a shaft furnace is generally identified by reference numeral 10 in FIG. 4. As seen in FIG. 4, the charging device comprises a distribution chute 20, that is rotatably supported within a drive housing 22 by means of a suitable bearing arrangement 24. A variable-speed drive 26, e.g. an electric motor, is connected to the distribution chute 20 by means of a suitable toothed gearing 28. As will be appreciated, the charging device 10 is configured to be arranged on the throat of a shaft furnace such as a blast furnace (not shown). The charging device 10 is configured concentrically to the vertical furnace axis A such that the longitudinal axis of the distribution chute 20 (at standstill) coincides with axis A. As is apparent from FIGS. 4-6, the variable-speed drive 26 serves to rotate the distribution chute 20 about the vertical furnace axis A.

As further seen in FIG. 4, the distribution chute 20 is composed of several separate parts connected in lengthwise direction. From top to bottom, distribution chute 20 comprises an upper inlet channel 30 and first to fourth separate chute sections 32, 34, 36, 38. The chute sections 32, 34, 36, 38 are interlinked, i.e. articulated to one another, by means of revolute joints 40. In other words, the distribution chute 20 forms a freely articulated chain of successive small chute members referred to as chute sections 32, 34, 36, 38. Furthermore, the uppermost chute section 32 is linked to the inlet channel 30 which is rotatably supported by the drive housing 22 through bearing arrangement 24. The revolute joints 40 allow pivoting of the chute sections 32, 34, 36, 38 relative to one another and relative to the inlet channel 30. More precisely, each revolute joint 40 provides one rotational degree of freedom about a substantially horizontal joint axis (perpendicular to the plane of FIG. 4 and axis A). In FIG. 4, the revolute joints 40 are arranged with parallel joint axes that are coplanar at standstill of the distribution chute 20. As further seen in FIG. 4, the revolute joints 40 are arranged to connect and articulate the lower end portion of the adjacent upper chute section to the upper end portion of the adjacent lower chute section with respect to each pair of adjacent chute sections (32,34); (34,36); (36-38). Similarly, the uppermost revolute joint articulates the upper end of the uppermost chute section 32 to the lower end of the inlet channel 30.

The inlet channel 30 is a cylindrical tube, into the upper end of which charge material is received during charging of the furnace. Each chute section 32, 34, 36, 38 has the shape of a funnel tapering downwardly. As regards geometric shape, the chute sections 32, 34, 36, 38 in FIGS. 1-7 are designed according to a frusto-conical rotationally symmetrical surface shell. The chute sections 32, 34, 36, 38 have substantially equal length in flow direction. The inlet channel 30 together with the concatenated interlinked chute sections 32, 34, 36, 38 suspended on the inlet channel 30 form a passage for charge material flowing downwardly there through. As regards weight distribution, the distribution chute 20 of FIG. 4, including inlet channel 30 and chute sections 32, 34, 36, 38 is balanced with respect to its longitudinal axis, i.e. its axis of rotation A.

In FIG. 5, a second embodiment of a charging device 10′ comprises a distribution chute 20′ that has a configuration generally similar to the previous embodiment. The distribution chute 20′ differs from the distribution chute 20 in that the lowermost revolute joint 41 has its joint axis slightly horizontally offset from the axis of rotation A at standstill. The joint axis of revolute joint 41 is parallel to the joint axes of the other revolute joints 40. The offset revolute joint 41 renders the distribution chute 20′ unbalanced in rotation. As will be understood, such an offset may also be provided at a different joint axis or at various joint axes in order to unbalance the distribution chute 20′.

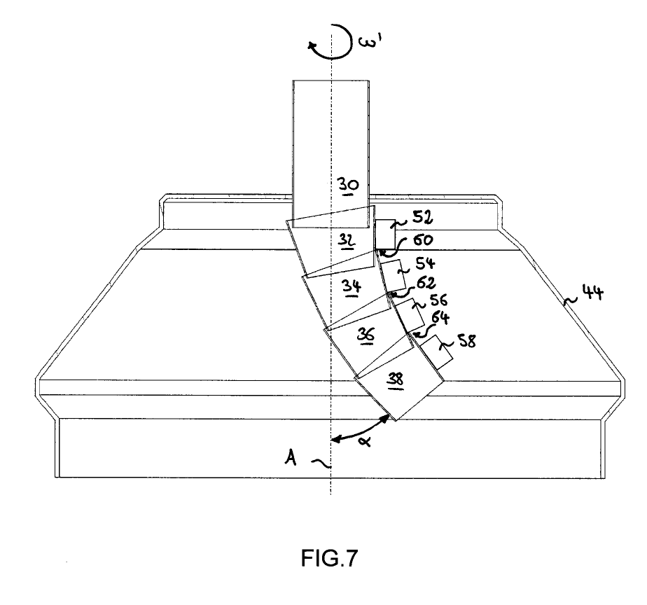

In FIG. 6, a third embodiment of a charging device 10″ comprises a distribution chute 20″ that has a configuration generally similar to the previous embodiments. The distribution chute 20″ differs from the distribution chute 20 in that it comprises an unbalancing weight 42 that is attached to one point or portion of the circumference of the lowermost chute section 38, in order to unbalance the distribution chute 20″ with respect to its axis of rotation A. By means of the unbalancing weight 42, the barycentre of the chute section 38 is made eccentric with respect to the longitudinal axis of the distribution chute 20″. As will be understood, such an unbalancing weight 42 may also be provided at a different chute section or at more than one or all chute sections 32, 34, 36, 38 (see FIG. 7) in order to unbalance the distribution chute 20″. Furthermore, an offset of one or more joint axes may be applied in combination with the unbalancing weight 42 if required.

The operation of a charging device 10, 10′, 10″ according to the invention will become more apparent from the following description of FIGS. 1 to 3. Although reference signs of the first embodiment will be used, it will be understood that the following description applies also to the second, third and fourth embodiments.

FIG. 1 shows the distribution chute 20 at standstill, i.e. when the distribution chute 20 is not rotating. As seen in FIG. 1, the distribution chute 20 together with the remaining parts of the charging device 10 (not shown) is installed on top of a blast furnace, i.e. on the furnace throat 44. The distribution chute 20 forms an articulated tube that is substantially vertical at standstill due to the freely pivotable revolute joints 40. It may be noted that at standstill the distribution chute 20 permits centre charging, i.e. directing the burden into the centre region of the charging surface, also called stockline, of the furnace. Especially as regards centre charging, it will be appreciated that with respect to each pair of adjacent chute sections (32-34), (34-36), (36-38), the lower chute section is smaller than the upper chute section in terms of the funnel apex angle and the funnel outlet diameter as seen in FIG. 1. Thereby a centering effect is achieved such that the flow of charge material is made to converge at the outlet of the lowermost chute section 38. Thereby, improved targeting of the charge material is achieved, both during centre charging and also during circumferential charging.

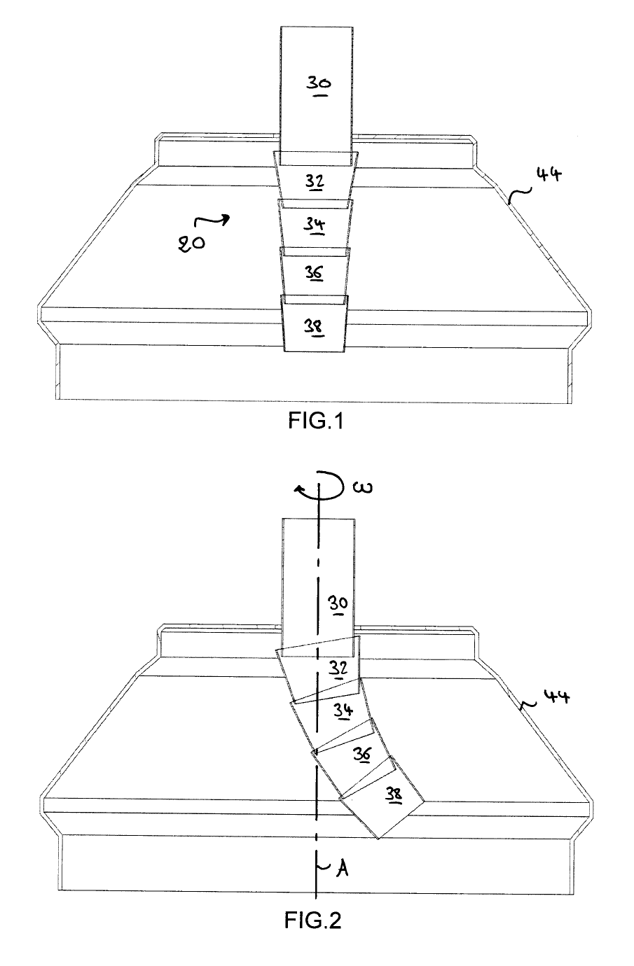

FIG. 2 shows the configuration of the distribution chute 20 at a given speed of rotation ω about axis A. As will be appreciated, the distribution chute 20 is configured to form a curved channel for radially distributing bulk material on the charging surface in function of the speed of rotation ω of the distribution chute 20. This is achieved due to the freely pivotable connection between the chute sections 32, 34, 36, 38 and the inlet channel 30 and by taking advantage of the effect of the centrifugal force. Since the centrifugal force is proportional to the square of the speed of rotation ω, the degree of curvature of the distribution chute 20 and in consequence the point of impact of the burden in radial direction can be adjusted by adjusting the speed of rotation only. No further actuation of the distribution chute 20 is required. Hence, by virtue of the design of the distribution chute 20 (20′, 20″ or 20′″) the charging device 10 (or 10′ or 10″) allows circumferential and radial burden distribution only by means of rotation of the distribution chute 20. Thereby the charging device 10 (or 10′ or 10″) enables achieving a wide variety of charging profiles without requiring a complex drive equipment. It should be noted that due to the funnel shaped configuration of the chute sections 32, 34, 36, 38, a partially interpenetrating overlapping arrangement of the latter and the inlet channel 30 is achieved so as to maintain a circumferentially and lengthwise enclosed tubular channel for the burden up to the maximum degree of curvature.

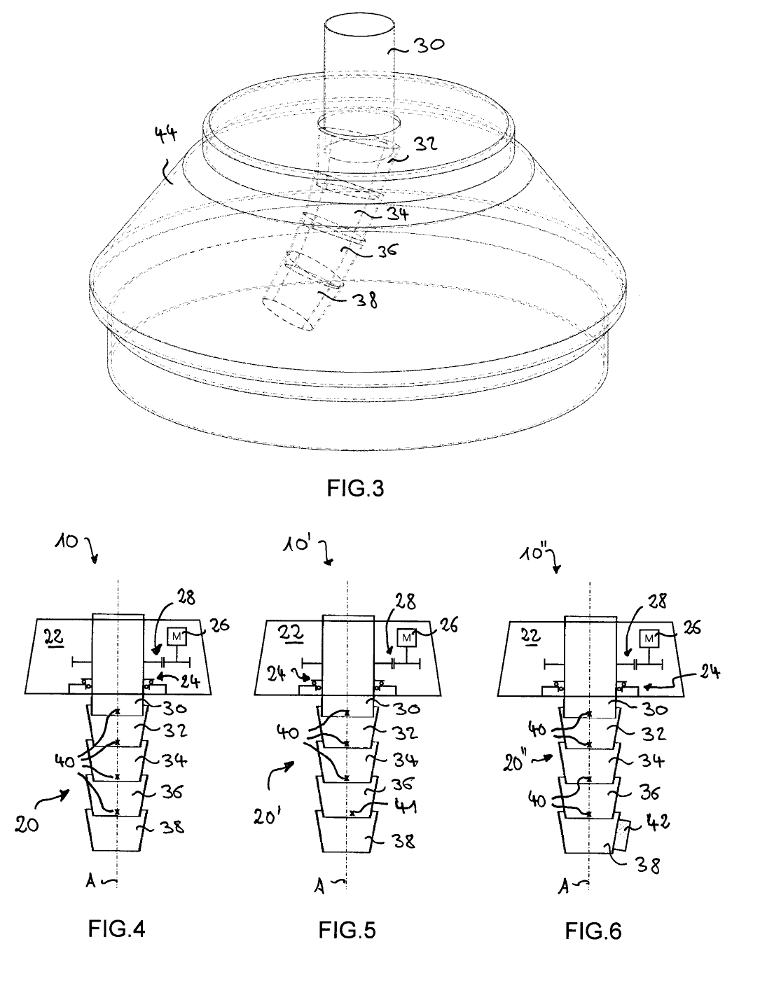

FIG. 3 illustrates the curved distribution chute 20 as seen in FIG. 2 in perspective view. Although chute sections 32, 34, 36, 38 with rotationally symmetrical frusto-conical surface shells are shown in the figures, it will be understood that the chute sections need not be circumferentially closed. They may for example be trough-shaped, i.e. open on one side. It is however preferred, that the chute sections are configured so as to prevent the burden to be exposed to aerodynamic drag before it exits the lowermost chute section 38 in order to avoid unnecessary segregation. Furthermore, it should be noted that segregation is reduced over prior art devices due to the considerable total length of the distribution chute 20 when compared to prior art chutes.

FIG. 7 shows a further embodiment with a distribution chute 20′″ that comprises four interlinked chute sections 32, 34, 36, 38 forming a curved channel at a given speed of rotation ω′. In extension to the embodiment of FIG. 6, the distribution chute 20′″ of FIG. 7 comprises, for each chute section 32, 34, 36, 38, a corresponding unbalancing weight 52, 54, 56, 58 attached to its chute section 32, 34, 36, 38 respectively. Each of the three upper unbalancing weights 52, 54, 56, is configured and attached to its respective chute section 32, 34, 36, so as to form a mechanical limit stop 60, 62, 64 for limiting the maximum inclination of the subsequent, i.e. the chute section following downstream. Although not shown, it will be understood, that for the uppermost chute section 32 a dedicated limit stop, which has no unbalancing function, can easily be provided e.g. on the upper inlet channel 30 or the uppermost revolute joint. At the speed of rotation ω′ (and at any higher speed of rotation >ω′ for a given mass flow of burden), the upper edge of each subsequent funnel shaped chute section 34, 36, 38 abuts to the lower face of the unbalancing weight 52, 54 or 56 respectively. Other configurations are also possible, e.g. with subsequent unbalancing weights abutting on each other. By limiting the maximum inclination angle of each chute section 32, 34, 36, 38 and thereby limiting the maximum curvature of the distribution chute 20′″, a collision of the chute 20′″ with the shell of the furnace can be avoided. Furthermore, the maximum radius to which burden can be charged is thereby limited, e.g. to avoid collision of charge material with the furnace shell. FIG. 7 illustrates the maximum inclination angle α for the lowermost chute section 38. As is apparent from FIG. 7, the inclination angle of each respective chute section 32, 34, 36, 38 increases from the uppermost chute section 32 to the lowermost chute section 38. It may be noted that, irrespective of the presence of limit stops, the overall achievable angle α for a given speed of rotation, will be dependent of and increase with the total number of chute sections. As will be appreciated, the limit stops also 60, 62, 64 also enable stabilization of the distribution chute 20′″ in a maximum curvature configuration, in particular when the speed of rotation is set equal to or greater than the lowest speed at which all chute sections 32, 34, 36, 38 are at maximum inclination.

When determining the relationship between speed of rotation and the radial point of impact, the weight and the centripetal effect of the charge material on the distribution chute 20 have to be taken into account of course. This can be achieved through analytical or empirical methods readily available to those skilled in the art. Although circumferential distribution based on centrifugal curving of the distribution chute 20 can be achieved when the distribution chute 20 is balanced in rotation, it may be preferred to provide a distribution chute 20, 20′ with a predetermined unbalanced configuration. Such predetermined unbalance can contribute to simplifying controlling the chute curvature and decrease the required speed of rotation for a given degree of curvature.

1.-16. (canceled)

17. A charging device for a shaft furnace, in particular for a blast furnace, said charging device comprising
a distribution chute that is supported to be rotatable about an essentially vertical axis of rotation, and
a variable-speed drive connected to said distribution chute in order to rotate said distribution chute for circumferentially distributing bulk material,
wherein said distribution chute comprises multiple chute sections that are interlinked by articulations in freely articulated manner so as to be capable of forming a curved channel having a degree of curvature due to centrifugal force for radially distributing bulk material on said charging surface, said degree of curvature of said curved channel due to centrifugal force being variable in function of speed of rotation of said distribution chute.

18. The charging device according to claim 17, wherein said distribution chute is unbalanced with respect to its axis of rotation.

19. The charging device according to claim 18, wherein at least one chute section comprises an unbalancing weight.

20. The charging device according to claim 18, wherein at least one pair of adjacent chute sections is interlinked by means of a revolute joint having its joint axis offset from said axis of rotation at standstill.

21. The charging device according to claim 17, wherein said distribution chute comprises at least three chute sections that are interlinked by articulations.

22. The charging device according to claim 21, wherein said chute sections are funnel shaped and have substantially equal length in flow direction.

23. The charging device according to claim 22, wherein, with respect to a pair of adjacent chute sections, a first chute section of said pair is smaller in terms of funnel apex angle and funnel outlet diameter than a second chute section of said pair.

24. The charging device according to claim 17, comprising pairs of adjacent chute sections, wherein each pair of adjacent chute sections is interlinked by means of a revolute joint.

25. The charging device according to claim 24, wherein, with respect to a pair of adjacent chute sections, in which an upper chute section is linked by means of a revolute joint to a lower chute section, said revolute joint links a lower end portion of said upper chute section to an upper end portion of said lower chute section.

26. The charging device according to claim 25, wherein each revolute joint has a joint axis and said joint axes of said revolute joints are substantially perpendicular to said axis of rotation of said distribution chute and preferably parallel.

27. The charging device according to claim 17, wherein said chute sections are interlinked by means of freely pivotable joints configured such that said distribution chute forms a substantially vertical channel at standstill.

28. The charging device according to claim 17, wherein said distribution chute comprises a rotatably supported upper inlet channel connected to said variable-speed drive and wherein an uppermost of said multiple chute section is linked to a lower end of said inlet channel.

29. The charging device according to claim 17, wherein said distribution chute comprises limit stops for limiting said degree of curvature.

30. A distribution chute for a charging device of a shaft furnace, in particular of a blast furnace, said chute having an axis and comprising multiple chute sections that are interlinked by articulations in freely articulated manner so as to be capable of forming a curved channel having a degree of curvature due to centrifugal force, said degree of curvature of said curved channel due to effect of centrifugal force being variable in function of speed of rotation of said distribution chute about said axis.

31. The distribution chute according to claim 30, said distribution chute being unbalanced with respect to said axis.

32. The distribution chute according to claim 30, wherein said distribution chute comprises at least three funnel-shaped chute sections of substantially equal length that are interlinked by articulations.

33. The distribution chute according to claim 32, wherein, with respect to a pair of adjacent chute sections, a first chute section of said pair is smaller in terms of funnel apex angle and funnel outlet diameter than a second chute section of said pair.

34. The distribution chute according to claim 30, comprising pairs of adjacent chute sections that are interlinked by articulations in freely articulated manner, each pair of adjacent chute sections being interlinked by means of a revolute joint having a joint axis, said joint axes being preferably parallel and being substantially perpendicular to said axis of said distribution chute.

35. The distribution chute according to claim 30, wherein said distribution chute comprises limit stops for limiting said degree of curvature.

36. A blast furnace charging device comprising
a distribution chute that is rotatable about an axis of said blast furnace and comprises multiple chute sections that are interlinked by articulations in freely articulated manner so as to be capable of forming a curved channel, and
a variable-speed drive for rotating said distribution chute about said axis for circumferentially distributing bulk material on a charging surface of said blast furnace
wherein said distribution chute is capable of forming a curved channel for radially distributing bulk material on said charging surface, said curved channel having a degree of curvature that is due to centrifugal force and thereby variable in function of speed of rotation of said distribution chute.
